(19) United States
(12) Patent Application Publication
(10) Pub. No.: US 2020/0148087 A1
(43) Pub. Date: May 14, 2020

(54) CART FOR TRANSPORTING AQUATIC VESSELS

(71) Applicant: Janie Leatherman, Bridgeport, CT (US)

(72) Inventor: Janie Leatherman, Bridgeport, CT (US)

(21) Appl. No.: 16/598,141

(22) Filed: Oct. 10, 2019

Related U.S. Application Data
(60) Provisional application No. 62/743,694, filed on Oct. 10, 2018.

(51) Int. Cl. B60P 3/10; B60T 3/00

(52) U.S. Cl. CPC B60P 3/1066; B60T 3/00

(57) ABSTRACT

A cart for transporting an aquatic vessel is provided which includes an axle, at least two wheels arranged on the axle, a frame having support posts extending from the frame to support the aquatic vessel, at least two elongated ties secured to the frame or the support posts, each having a wheel chock arranged thereon configured to be removably placed adjacent to one of the at least two wheels to stabilize the cart at rest, and a kickstand. The cart and its components can be disassembled in a variety of different configurations to allow the cart to be stored in a number of different configurations, including inside of the aquatic vessel, when the cart is not in use.

### CROSS-REFERENCE TO RELATED APPLICATIONS

The present application claims the benefit of U.S. Provisional Patent Application No. 62/743,694 filed Oct. 10, 2018, which is hereby incorporated by reference in its entirety.

### BACKGROUND OF THE INVENTION

Kayakers face one critical dilemma: transporting their kayak to the water. This is most challenging over soft sand and more daunting still if it means slogging uphill on the way back. A kayak cart should provide an easy, workable solution. However, kayakers expend so much energy with cart problems that it limits their enjoyment on the water and amount of time they can actually spend kayaking. This problem is pervasive for many women and for older persons or those with injuries or physical limitations. It presents barriers to youth participation. And even healthy and strong people struggle and get frustrated.

The poor functioning of kayak carts that dominant the market is the Achilles heel of an industry that has nonetheless experienced extraordinary growth over the last 25 years and a great deal of innovation in kayak design and material.

A number of equipment problems related to the main types of kayak carts on the market have produced these difficulties. One source of the problems concerns the way the cart is secured to the kayak. This is typically done with straps that have to be fed through metal teeth (a tedious routine) or sometimes with bungie cords. The kayak can slip from the cart with either system. The bungie cords can also stretch so much that the cart ends up far behind the kayak. A common cart design that uses the straps also has problems with stability. It tends to collapse on loading or while loading is underway.

Another source of problems concerns the position of the carts. Most are designed to go toward the rear of the kayak. This includes carts that use uprights to pass through the rear scuppers on Sit-on-Top kayaks. That means the kayaker, who will have to pull the boat from a handle at the very front, will end up bearing nearly the whole weight of the kayak instead of the cart carrying the load. Carts that go under the very end of the kayak cause even more strain.

Many carts weigh 7 to 12 pounds, adding to the weight load. Wheels designed especially for sand help move the kayak more easily, but not much if the cart is under the end of the boat.

Meanwhile, there are very few kayak cart models on the market for Sit-Inside kayaks that use the sand wheels. The carts sold for this kind of kayak also typically go under the stern; or if they can be placed under the mid-section of the kayak, they are often the type that is prone to collapse.

### SUMMARY OF THE INVENTION

The present invention addresses these shortcomings of the art by providing an improved cart for transporting a kayak or other aquatic vessel. The kayak cart includes at least two wheels arranged on an axle, a frame including support posts to support the kayak and a pair of ties having wheel chocks arranged thereon to help stabilize the cart on loading and to secure the kayak to the cart quickly and dependably. The kayak cart is configured to be lightweight for ease of use and can be disassembled for easy storage.

In accordance with the present application, a cart for transporting an aquatic vessel is provided, comprising: an axle, at least two wheels arranged on the axle, a frame having support posts extending from the frame configured to support an aquatic vessel, at least two elongated ties secured to the frame or the support posts, each of the at least two elongated ties having a wheel chock arranged thereon configured to be removably placed adjacent to one of the at least two wheels to stabilize the cart at rest, and a kickstand.

In one embodiment of the cart, the frame comprises an elongated member and the support posts comprise at least two support posts secured to and extending from the elongated member. Each of the at least two support posts may be T-shaped support posts comprising an upright post secured to the frame and a cross post secured to the upright post, wherein the cross post comprises padding arranged thereon. In additional embodiments, each of the at least two T-shaped support posts may also be removable from the frame, have an adjustable height, and/or comprise a hook element, each hook element configured to receive an end of one of the at least two elongated ties. In a further embodiment, each of the at least two T-shaped support posts may also be rotatable at least 90 degrees relative to the elongated member

In a further embodiment of the cart, which may be in addition or alternative to the aforementioned embodiments, the kickstand extends from at least one of the cross post of at least one of the T-shaped support posts. In one such embodiment, the kickstand comprises: a foot at a first end of the kickstand and a swivel joint at an intermediate portion of the kickstand adjacent to the cross post configured to enable rotational movement of the kickstand, and the kickstand is configured to be retractable into and out of a hollow passage formed through the cross post. In a further such embodiment, the kickstand further comprises a flange at a second end of the kickstand disposed within the hollow passage, wherein the flange has a greater diameter than a lip or throat in the hollow passage formed through the cross post. In alternative embodiments, the kickstand is attached to the elongated member of the frame in between the support posts, or in between one of the support posts and one of the wheels.

In a further embodiment of the cart, which may be in addition or alternative to the aforementioned embodiments, the axle is received in the elongated member of the frame and may be secured to the frame by a spring release button clip. In certain embodiments, the axle has an adjustable length.

In a still further embodiment of the cart, which may be in addition or alternative to the aforementioned embodiments, the wheels are attached to the axle with a quick release pin and the wheels comprise a bushing configured to receive the axle. The cart may further comprise in additional embodiments, a coupling attached to the end of the axle configured to accommodate wheels of variable sizes.

In another embodiment of the cart, which may be in addition or alternative to the aforementioned embodiments, the at least two elongated ties are made of a flexible and moldable material, such as a material comprising a wire interior and an exterior comprising a gripping surface. The wheel chocks may also comprise a surface having a plurality of bumps, groove or projections thereon to providing a gripping surface, and the wheel chocks are configured to grip a side of the aquatic vessel during transport of the aquatic vessel on the cart.

### BRIEF DESCRIPTION OF THE FIGURES

FIG. 1A shows a first, exploded view of a cart according to an embodiment of the present application;

FIG. 1B shows a second, exploded view of a base of a cart according to an embodiment of the present application;

FIG. 2A shows a first view of a cart according to an embodiment of the present application;

FIG. 2B shows a second view of a cart according to an embodiment of the present application;

FIG. 3A shows a further view of a disassembled cart according to an embodiment of the present application;

FIG. 3B shows a coupling for adjusting the wheels of the cart according to an embodiment of the present application;

FIG. 3C shows a spring clip button on an axle for securing to a frame of the cart according to an embodiment of the present application;

FIG. 3D shows a spring clip button of the cart according to the present application;

FIG. 3E shows a quick release pin of a cart according to the present invention;

FIG. 3F shows a view of an inner portion of a cart according to an embodiment of the present application;

FIG. 4 shows a cart according to a further embodiment of the present application;

FIG. 5A shows a detachable kickstand positioned close to one of the wheels attached with a snap clip tee according to an embodiment of the present application;

FIG. 5B shows a snap clip for attaching a detachable kickstand to the axle of the cart of an embodiment of the present application;

FIG. 5C shows a 180-swivel hinge for allowing a kickstand of an embodiment of the present application to rotate 180 degrees;

FIG. 6A-6E show a cart with a retractable kickstand that is housed within one of the landing posts;

FIG. 7 shows a cart according the present application used in transporting a kayak;

FIGS. 8A-8D show the storage of a cart on top of a kayak; and

FIGS. 9A-9C show a cart according to an embodiment of the present application dissembled for storage inside a kayak.

### DETAILED DESCRIPTION OF THE INVENTION

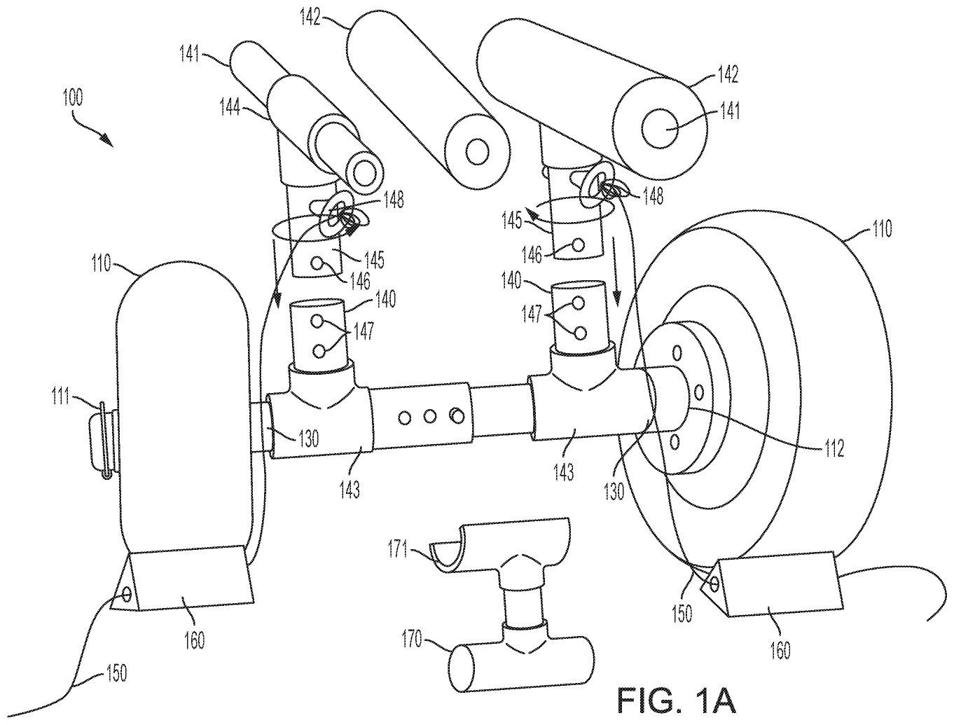

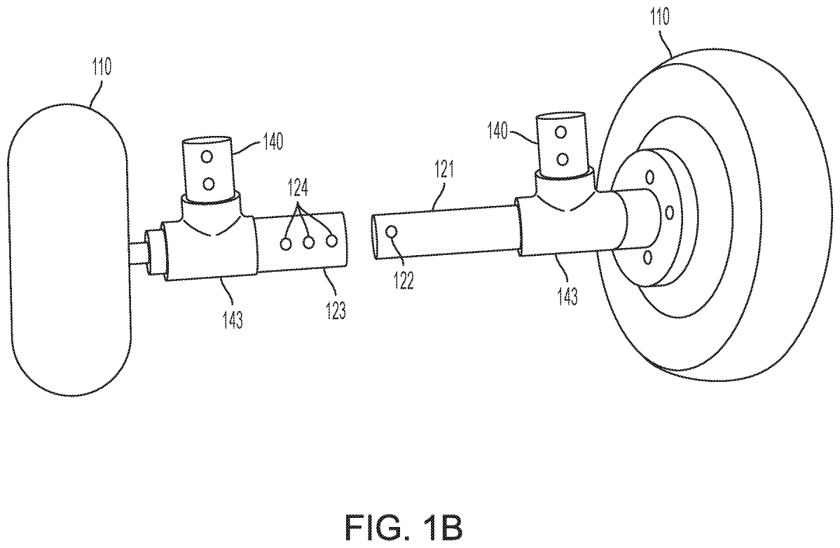

The cart 100 of the present application will now be described with reference made to FIGS. 1-9C.

In a preferred embodiment shown in the Figures, the cart 100 comprises two wheels 110, an axle 120, and a frame 130 including two uprights posts 140, each post 140 having a landing support bar 141 to support the bottom of the kayak 200.

The kayak cart 100 comprises a pair of wheels 110 arranged on an axle 120. In preferred embodiments of the cart 100, as shown for example in FIGS. 1A-3F, the wheels 110 are beach wheels, which are known in the art as being designed for transporting objects across sand-covered surfaces. The wheels 110 may be made of polyurethane, including but not limited to WHEELEEZ brand polyurethane balloon beach wheels.

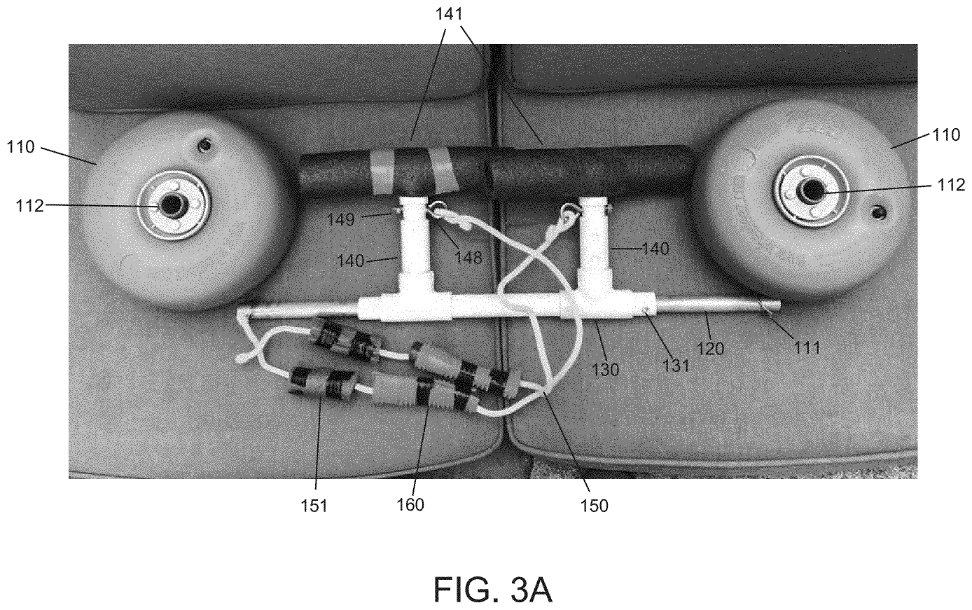

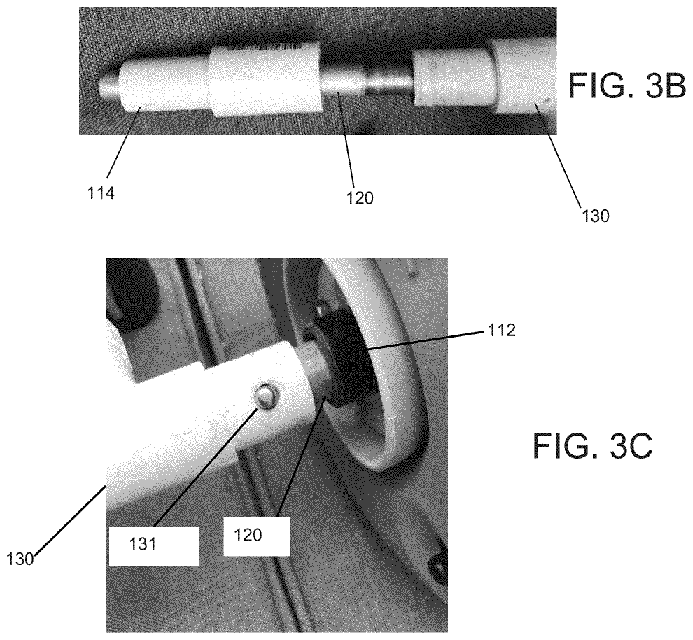

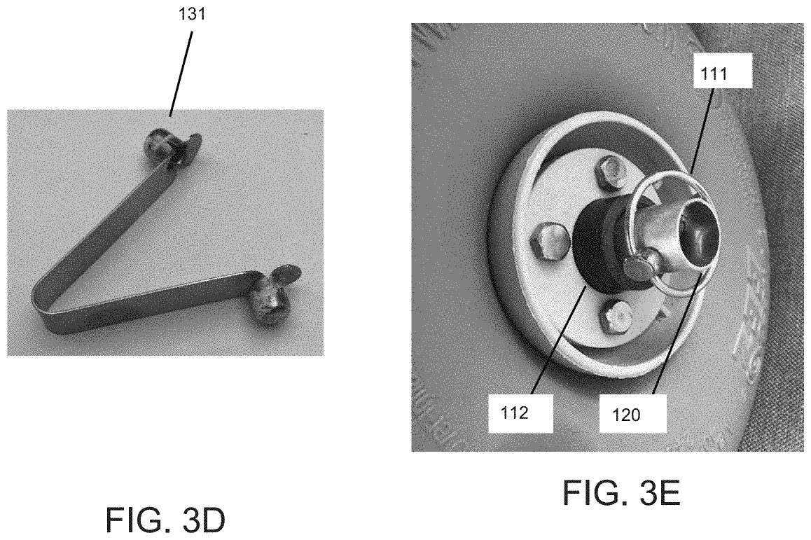

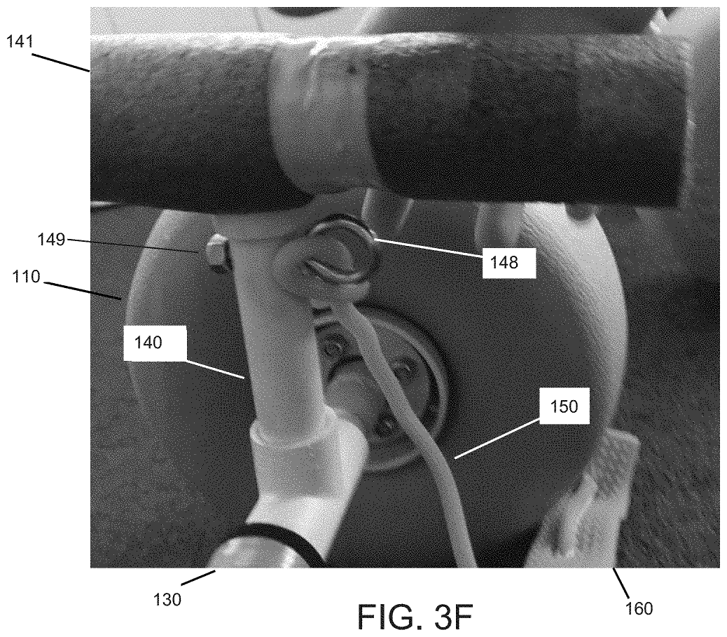

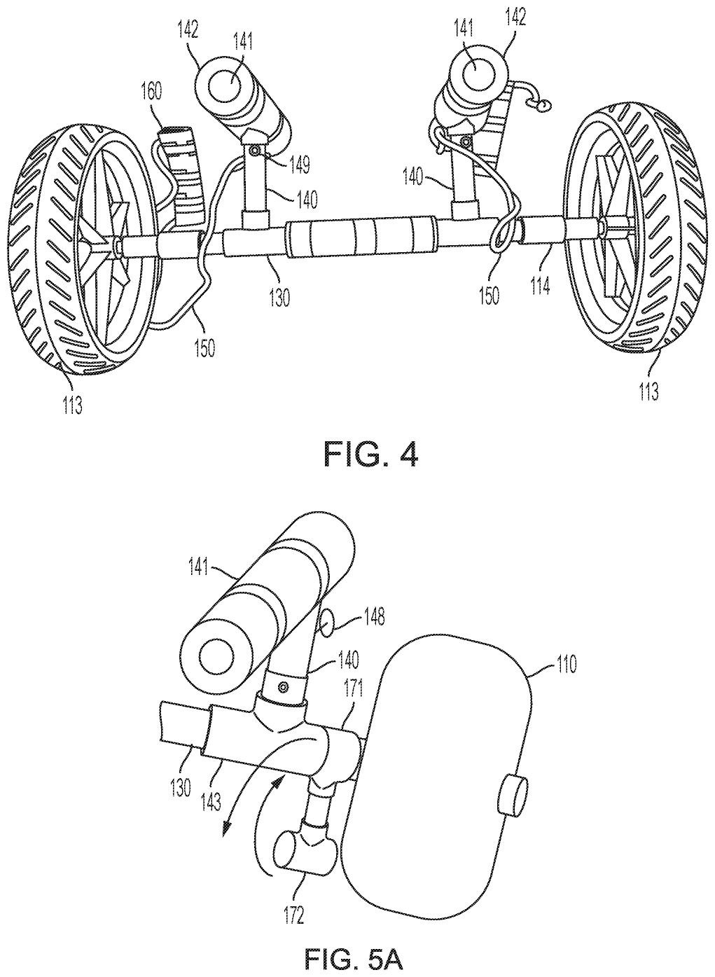

The wheels 110 of the kayak cart 100 may be attached to the axle 120 with a quick release pin 111, as shown for example in FIG. 3E. The quick release pin 111 makes it possible to easily remove the wheels 110 for storage and also to alternate tires used on the cart 100 such as alternating between polyurethane beach tires 110 designed for use in sand, and rubber or plastic tires 113 appropriate for other kinds of terrain (as shown for example in FIG. 4), or between different sizes of wheels or tires. Each of the wheels 110 may also be provided with a bushing 112 to receive the axle 120.

In the embodiments of the cart 100 shown for example in FIGS. 1A-7, the wheels 110 have a width of approximately four inches and a diameter of approximately nine inches. The bushing 112 may have a diameter of approximately 0.625 inches. In alternative embodiments of the cart 100, wheels 110 having different dimensions may be utilized in the cart 100. The frame 130 may also be provided with a frame adaptor to accommodate wheels of different widths.

The cart 100 can comprise a coupling/extender 114 that is the same diameter as the wheel bushing 112. An example of the coupling/extender 114 is shown in FIG. 3B. Using the coupling/extender 114, the cart 100 can use interchangeable tires of different dimensions. For example, the cart 100 may in one configuration comprise on each end one polyurethane wheel 110 with a width of four inches and in another configuration including the coupling/extender 114, one narrower hard rubber wheel 113 on each end, each approximately two inches wide. In such an embodiment, both types of wheels 110, 113 may have diameters of approximately nine inches.

The axle 120 of the kayak cart 100 may be a rod of an anodized aluminum, stainless steel, or another metal or plastic material. The cart 100 is also provided with a frame 130 that is configured to receive the axle 120 and support the kayak 200 during use of the cart 100. The frame 130 includes a hollow elongated section, arranged between the wheels 110, which is configured to receive the axle 120.

In alternate embodiments of the cart 100, the axle 120 may have an adjustable length, as shown in FIG. 1B. The axle 120 may comprise a ferrule or shaft 121 comprising a spring button clip 122 that is dimensioned to be received in the axle tubing 123 in a section comprising a plurality of openings 124 configured to receive the spring button clip 122, which can be a single or double spring button clip. The length of the axle 120 can be shortened or extended by pushing in the spring button clip 122, and allowing the button to pass through one of the openings 124. The openings 124 may be separated by a distance of one inch or by alternative distances. In other embodiments of the cart 100, the axle 120 has a fixed length, which in certain embodiments may be approximately 25 inches, and a diameter of approximately 0.625 inches.

The frame 130 can be fixed to the axle 120 using a double spring button clip 131. The frame 130 may be formed from hollow tubing, such as aluminum, stainless steel or PVC pipe having a diameter of 0.75 inches, or an alternate diameter configured to receive the axle 120. In alternative embodiments of the cart 100, the frame 130 may be made from other materials.

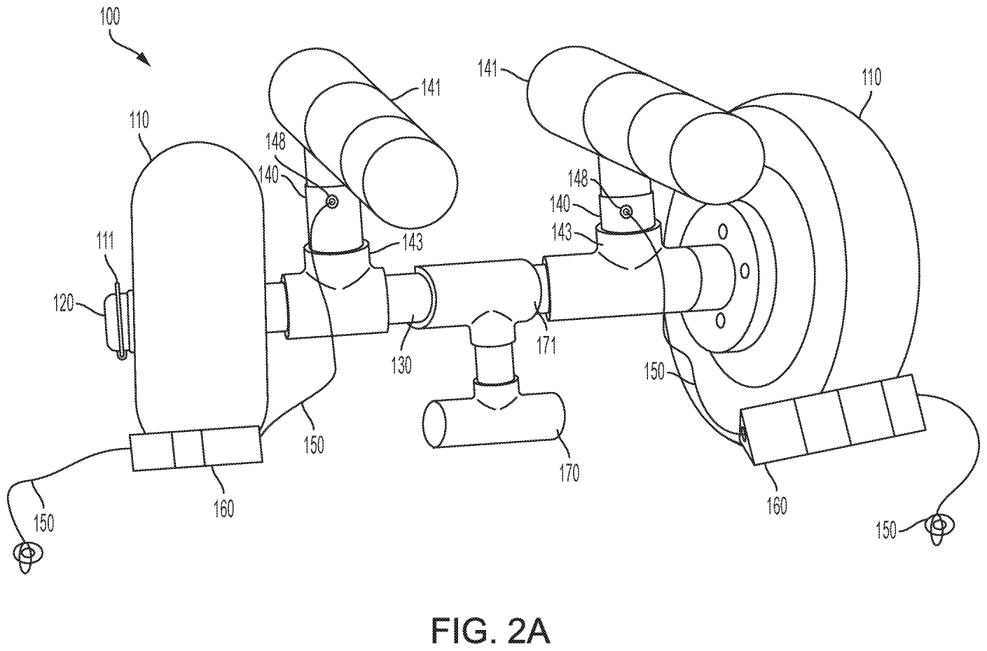

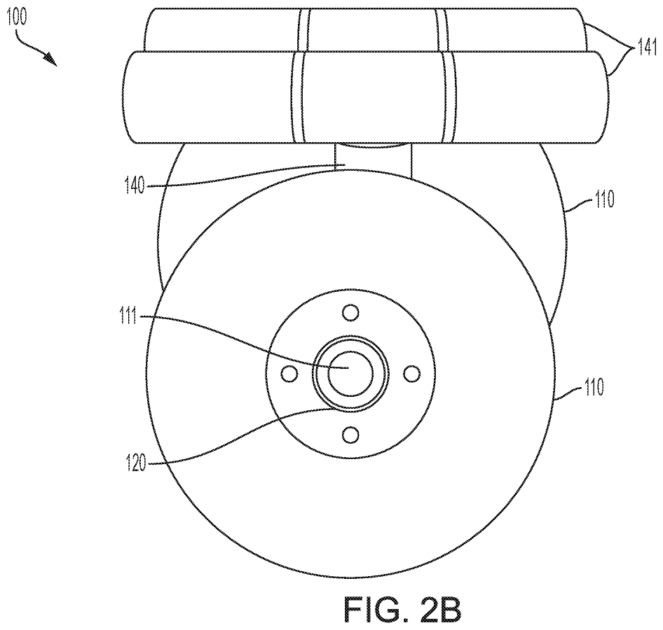

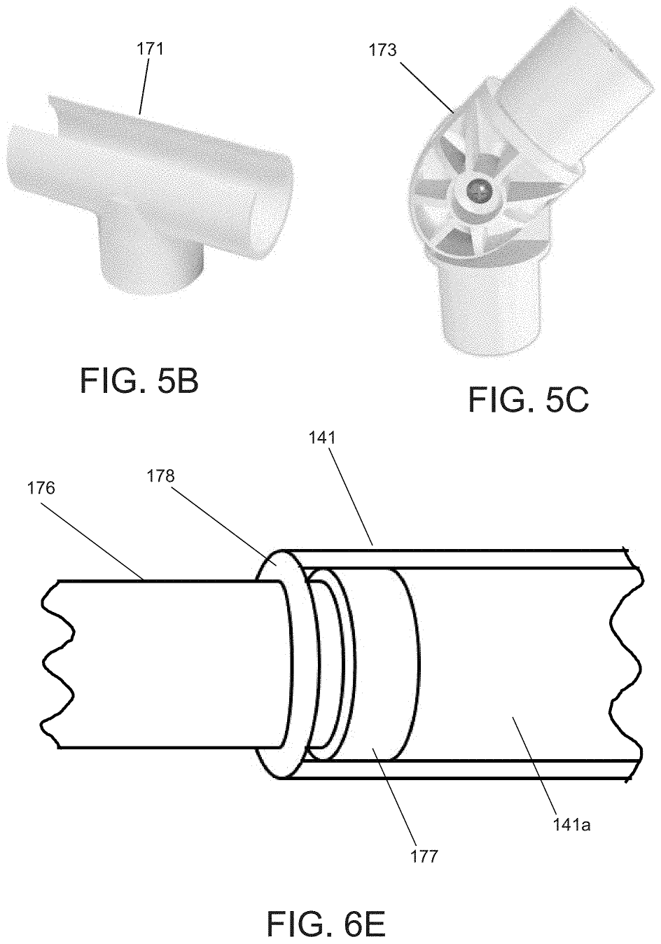

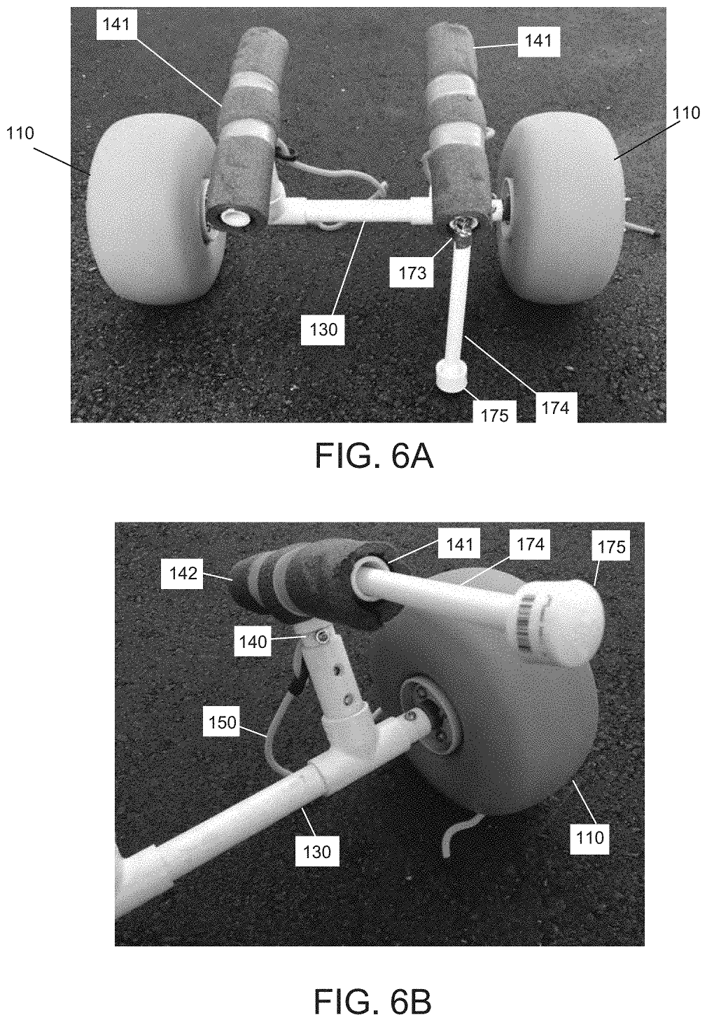

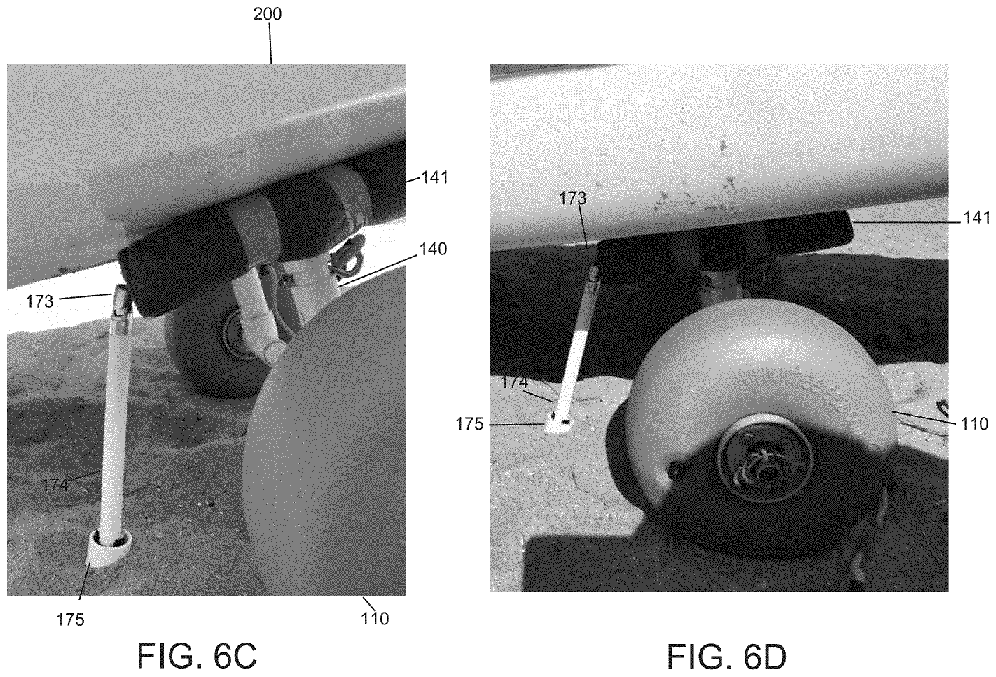

In certain embodiments of the cart 100, such as shown in FIGS. 1A-2B for example, a kickstand 170 may be connected to the frame 130 to aid in keeping the cart 100 upright and stabilizing the cart 100 during loading of the kayak 200. The kickstand 170 can be disconnected from the frame 130 when the kickstand 170 is not required, such as during periods of non-use of the kayak cart 100 when it is being stored. The kickstand 170 can be attached to the frame 130 by way of a T-shaped snap clip 171, which has an opening on the base to receive an end of the kickstand 170 and a perpendicular section having a lengthwise opening that allows the clip 171 to snap onto or off of the frame 130. The kickstand 170 can be made of the same or different material as the frame, including for example PVC pipe, anodized aluminum or stainless steel. In alternative embodiments, an upright sleeve can be provided into which the kickstand 174 is inserted in a telescoping fashion that enables the kickstand 174 to be lengthened or shortened for transport or storage. In other embodiments of the cart 100, such as shown in FIG. 4 for example, the cart 100 may be provided without a kickstand. Additional embodiments of the kayak cart 100 including a kickstand 174 are shown in FIGS. 5A-6E and described in further detail below.

The frame 130 also comprises at least two upright support posts 140 that are configured to support the kayak 200 during use of the kayak cart 100. In a preferred embodiment shown in the Figures, the posts 140 are T-shaped with padded, support bars 141 arranged on the top of the posts 140. The posts 140 and supporting cross bars 141 may be made of a similar or different materials as the frame, including for example PVC pipe, anodized aluminum tube or stainless steel tube having a diameter of 0.5 or 0.75 or 1 inch. In embodiments in which the cross bars 141 are made from a hollow tube, the cross bars 141 may include end caps arranged over the hollow openings to close off the tubing. In embodiments of the cart 100 including wheels 110 having a diameter of nine inches, the upright posts 140 may have a height of at least 4.5 inches from the top surface of the frame 130 to the bottom surface of the cross bar 141.

The posts 140 can be permanently connected to the frame 130 or can be connected in a way that enables the posts 140 to be removed. In one embodiment shown in the Figures, each of the posts 140 can be attached to the frame 130 by way of a T-shaped snap clip 143, which has an opening to receive an end of the post 140 and a perpendicular section having a lengthwise opening that allows the clip 143 to snap onto or off of the frame 130. In other embodiments, each of the posts 140 can attached to the frame 130 by way of a T-shaped connector, which is similarly configured to the snap clip 143 but does not have a lengthwise opening, and the connector positioned on the frame 130 or removed from the frame 130 when one of the wheels 110 is removed from the axle 120. In alternative embodiments, the posts 140 can be removably attached to the frame 130 in other manners, such as by way of a screw thread arrangement, a press fit arrangement, or other suitable locking arrangements known in the art. In a further embodiment, the cart 100 has an axle 120 made of aluminum or stainless steel, for example, on which the posts 140 are directly attached, and the cross-posts 141 are in turn attached to the posts 140.

Each of the posts 140 can also be permanently connected to the perpendicular cross bar 141 or can be connected in a way that enables the posts 140 and cross bars to be separated. In one embodiment shown in the Figures, each the posts 140 can be connected to a cross bar 141 to the frame 130 by way of a T-shaped connector 144, which has an opening to receive an end of the post 140 and a hollow perpendicular section configured to receive the cross bar 141. Alternatively, the T-shaped connector 144 may be a snap-clip, having a lengthwise opening that allows the clip to snap onto or off of the cross bar 141. In alternative embodiments, the post 140 can be removably attached to cross bar 141 in other manners, such as by way of a screw thread arrangement, a press fit arrangement, or other suitable locking arrangements known in the art.

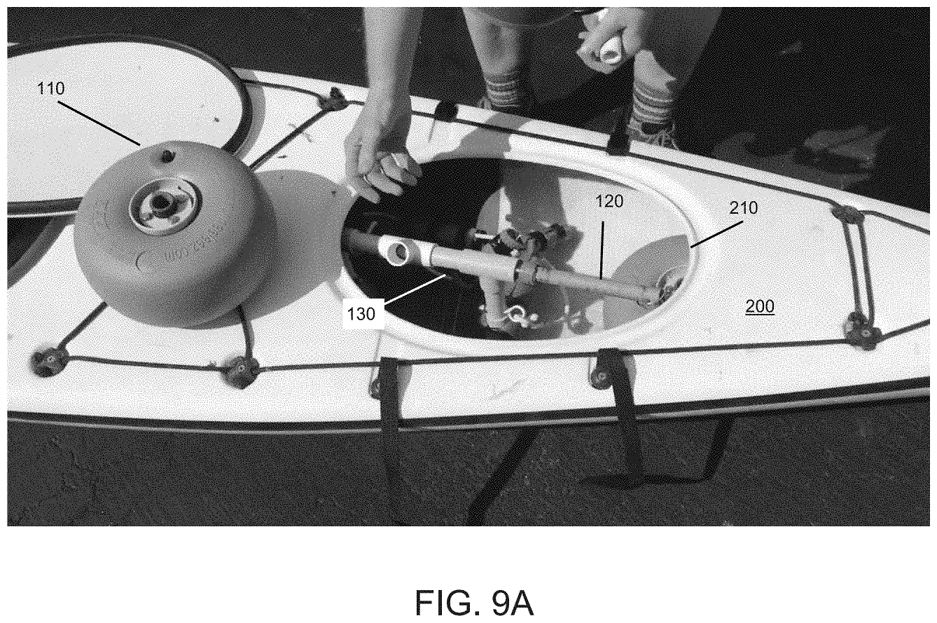

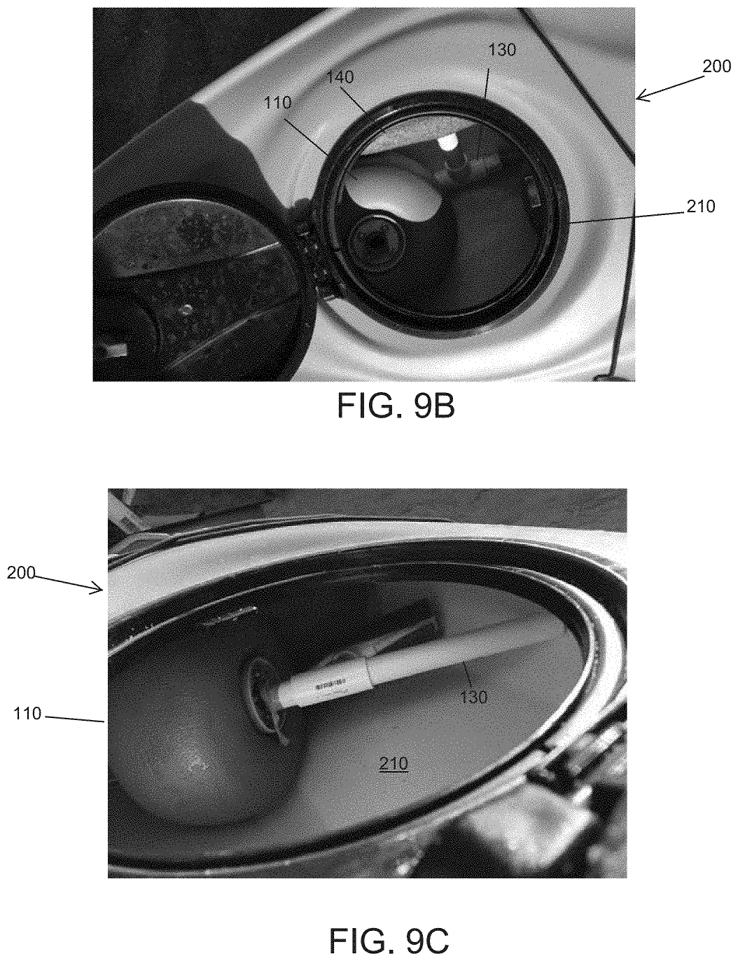

As shown in the embodiments illustrated in FIGS. 1A-1B, each of the posts 140 may also be configured with a ferrule or shaft 145 with a single or double spring button clip 146 which enables the posts 140 to be raised and lowered, and also allows for the post 140 to be rotated, such that the padded support bars 141 can be turned to be parallel with the frame 130 and axle 120. An example of a spring button clip 146 used in the cart is shown in FIG. 3D. The post 140 comprises a plurality of spaced apart openings 147 configured to receive the spring button clip 146, which enable the height of the post 140 to be increased or decreased. The openings 147 can be spaced apart by approximately one inch in a preferred embodiment, or spaced apart by other dimensions in alternative embodiments. The use of the spring button clips 146 on the posts 140 also makes it possible to disengage the button to rotate the posts 140 and cross bars 141 ninety degrees so the cross bars 141 are horizontal or parallel to the axle 120, as shown in FIG. 3A. In this position, it is possible to store the frame 130 with the axle 120 in a ten-inch hatch 210 of a kayak 200, with wheels 110 removed and placed in hatch 210 beside the frame 130 and axle 120, as shown for example in FIGS. 9B-9C. In alternative embodiments, an upright sleeve can be provided into which the post 140 is inserted in a telescoping fashion or with a threaded screw mechanism that enables the post 140 to be raised and lowered.

The cross bars 141 of the posts 140 can be covered in a foam material 142, or another soft or padded material 142 known in the art. In a preferred embodiment, the foam or other padding 142 covering the cross bar 141 has a surface texture that is configured to provide a gripping effect on the kayak 200 to aid in preventing the kayak 200 from sliding off of the support bars 141. In the embodiments shown in the Figures, the padded cross bars 141 have a diameter of approximately 2.25 inches and a length of approximately 10 inches.

The cart 100 further comprises an eyehook 148 on each upright post 140 to anchor a tie 150 under each cross-bar 141. The eyehook 148 may be affixed to the post 140 by inserting a threaded end of the eyehook 148 through an opening in one side of the post 140 and securing the eyehook 148 in place with a nut 149 over the threaded end on the opposite side of the post 140.

The tie 150 is used to secure the cart 100 to the kayak 200, as shown for example in FIGS. 9A-9C. The ties 150 can be secured on any fixed point on the kayak 200, such as the carry handles on the side of the kayak 200, around the kayak seat frame or straps that secure the seat to the kayak 200. The ties 150 grip the kayak 200 at any point of contact, thus securing the kayak 200 on the cart 100 while transporting it to the water and back.

In a preferred embodiment, the tie 150 is made of a flexible but moldable material. The ties 150 utilized in the cart 100 may include GEAR TIE brand tie products made by Nite Ize, Inc., including those described for example in U.S. Pat. Nos. 8,776,322, 8,387,216 and 8,806,723, which may include a rubber exterior and a wire interior. The outer material of the tie 150 preferably comprises a rough exterior configured to provide a grip on the kayak 200, while the material of the tie 150 is also deformable, such that it is possible to mold and twist the tie 150 into many shapes that can be retained by the tie 150. The ties 150 can be attached and removed from the kayak 200 in seconds.

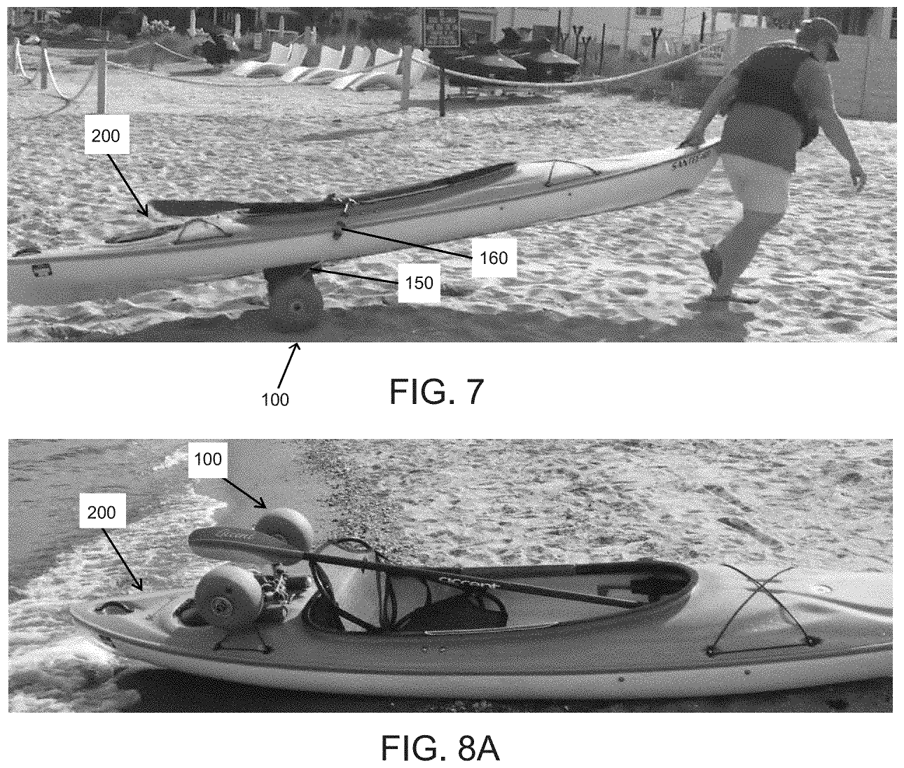

The tie 150 is also affixed to a sliding wheel chock 160 made from silicone or similar gripping material. The silicone chock 160 may comprise a plurality of bumps or projections that provide a gripping surface on the chock 160. Both the tie 150 and wheel chock 160 can be used to stabilize the cart 100 during loading. The chocks 160 can be arranged under the wheels 110 during loading of the kayak 200 to prevent the wheels 110 from moving during the loading of the kayak 200. The chock 160 is also configured to grip a side of the kayak 200 during transport, as shown for example in FIG. 7. This aids in preventing the kayak 200 from sliding off of the cart 100 during transport. The chock 160 can be in a round, cylindrical shape, a triangular shape, or may be substantially flat. In addition to the wheel chock 160 arranged on the tie 150, the tie 150 may also comprise an additional handle 151 on the end of the tie 150 to aid the user in loading the kayak 200 on the cart 100. The handle 151 also aids the tie 150 in grabbing the kayak 200.

In an alternative embodiment of the cart 100, shown in FIGS. 5A-5C, the kickstand 172 can be positioned close to one of the wheels 110, i.e., in between one of the upright posts 140 and one of the wheels 110. In that position, the kickstand 172 can rotate 180° up and down so that the kayaker can easily bend over and flip up the kickstand 172 before pulling the kayak 200. Keeping the kickstand 172 up while transporting the kayak 200 would avoid any drag from the sand. The kickstand 172 can be rotated 180° by mounting the kickstand 172 on the frame 130 using a 180° swivel hinge 173, as shown in FIG. 5C. Alternatively, the kickstand 172 can be rotated up and down with a T-shaped snap clip 171 as shown in FIG. 5B, which has an opening on the base to receive an end of the kickstand 172 and a perpendicular section having a lengthwise opening that allows the clip 171 to snap onto or off of the frame 130. In a further embodiment, a mount can be incorporated that comprises a push pin to alternate between an upright position to store while transporting the kayak on the cart and a down position while loading the kayak 200 on the cart 100.

FIGS. 6A-6E show a further alternative embodiment of the cart 100 comprising a telescoping, retractable kickstand 174 that can be housed in one of the landing posts 141. A swivel joint hinge 173, such as shown in FIG. 5C, which can be made from PVC or stainless steel allows the kickstand 174 to be pulled out of the landing post tube 141 and angled to the ground. An end cap 175 also serves as the “foot” for the kickstand 174, and may be made of PVC and have a rubber bottom or be made out of rubber or silicone to provide a grip on hard surfaces, such as rocks or pavement. As shown for example in FIG. 6E, which shows a cross-sectional view of a portion of the cross post 141, to keep the retractable kickstand 174 from coming completely out of the landing post tubing 141, the opposite end 176 of the kickstand 174 may comprise a flange 177 that will travel through interior 141a the cross post 141, but be too wide in diameter to pass through a lip 178 at the opening of the cross post 141, or a throat within the post 141, that has a narrower diameter than the rest of the interior 141a of the cross post 141. The far end of the landing post 141 may have a cap, so the kickstand 174 could not come out that side when retracted. The retractable kickstand 174 may include a universal joint, which can be a ¼ inch joint, that pivots on two axes, allowing 360 degrees of rotation, or may include a 180 degree rotating swivel joint 173 as shown in FIG. 5C. The kickstand 174 may also be adjustable using a single spring button clip that allows the kickstand 174 to extend an additional three to five inches. The kickstand 174 may also be retractable from the cross post 141 in a telescoping manner. When retracted into the cross post 141, the kickstand 174 can stay attached to the cross post 141 to avoid its falling out of the cross post 141 unintentionally. The end cap 175 can be configured to fit over the cross post 141 to secure the kickstand 174, or the end cap 175 can be removably attached to the cross post 141 by way of a screw thread arrangement, a press fit arrangement, or other suitable locking arrangements known in the art.

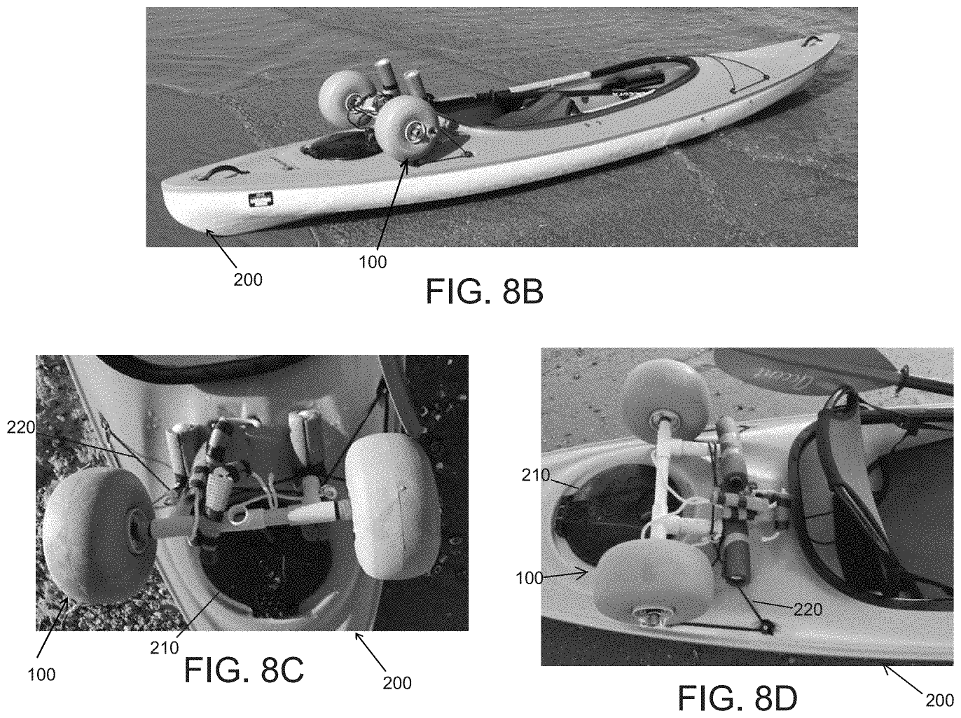

The cart 100 can be stored as one piece on top of the kayak 200, as shown for example in FIGS. 8A-8D, under rear or front deck lines 220, or inside the kayak 200 through the bow or stern hatch 210. The cart 100 can also be disassembled for more compact storage, as shown in FIGS. 9A-9C. The cart 100 can be quickly stored under the deck in a number of manners and configurations, including but not limited to: storing the cart 100 in one piece if the hatch 210 is large enough, with posts 140 removed from the frame 130, and wheels 110 on or off the axle 120, with the posts 140 rotated to place the pads 142 parallel to the axle 120, in which case the whole frame 130 with the axle 120 will fit in a ten-inch hatch 210, or by pulling the kayak cart 100 in half using the spring clip button 122 on the axle 120, such that the cart 100 could be stored in two pieces, each half having a wheel 110 attached to axle 120 with one post 140.

During loading, the cart 100 is preferably positioned under the mid-point of the weight of the kayak 200. This makes pulling the kayak 200 almost effortless. To load the kayak 200 on the cart 100, the cart 100 should be angled into the kayak 200 at about 20 degrees from the centerline, so that when the kayak 200 is placed on top, it is lined up and ready to be transported. The kayak 200 can be loaded onto the cart 100 by picking up the rear of the kayak 200 about one foot off the ground and moving it over top of the cart 100. It is also possible to engage the kickstand 170, 172, 174 to stabilize the cart 100, and the lift the kayak 200 into the air, and place it directly onto the cart 100 from above. The ties 150 of the cart 100 are secured to the kayak 200 as previously described so that the cart 100 and kayak 200 are secured together for transportation.

In a preferred embodiment, the cart 100 weighs approximately three to four pounds. It is ergonomic to carry in the hand, compact, and almost effortless to load, unload, and pull a kayak 200, or store on deck or in a hatch 210. The cart with polyurethane wheels 110 is also configured to float in the water. The cart 100 is stable and tracks straight even in soft sand.

An alternative, “heavy duty” version of the cart may also be provided, which may have a 1 inch, ½ inch or ¾ inch axle bushing 112, 11-12 inch diameter polyurethane balloon wheels 110, and overall axle length of 32 inches (extendable to about 35 inches). The rest of cart frame 130 would be proportional to these dimensions, including posts 140 having a lowest setting at least 2.5 inches higher than on the smaller cart 100.

Although the embodiments of the cart 100 are described herein in combination with a kayak 200, the cart 100 may be used to transport any number of aquatic vessels, including but not limited to canoes, small boats, and other watercraft.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice.

What is claimed:

1. A cart comprising:
an axle;
at least two wheels arranged on the axle;
a frame having support posts extending from the frame configured to support an aquatic vessel;
at least two elongated ties secured to the frame or the support posts, each of the at least two elongated ties having a wheel chock arranged thereon configured to be removably placed adjacent to one of the at least two wheels to stabilize the cart at rest; and
a kickstand.

2. The cart according to claim 1, wherein the frame comprises an elongated member and the support posts comprise at least two support posts secured to and extending from the elongated member.

3. The cart according to claim 2, wherein each of the at least two support posts are T-shaped support posts comprising an upright post secured to the frame and a cross post secured to the upright post, wherein the cross post comprises padding arranged thereon.

4. The cart according to claim 3, wherein each of the at least two T-shaped support posts is removable from the frame.

5. The cart according to claim 3, wherein each of the at least two T-shaped support posts has an adjustable height.

6. The cart according to claim 3, wherein each of the at least two T-shaped support posts comprises a hook element, each hook element configured to receive an end of one of the at least two elongated ties.

7. The cart according to claim 2, wherein the kickstand is attached to the elongated member of the frame in between the support posts.

8. The cart according to claim 3, wherein the kickstand extends from at least one of the cross post of at least one of the T-shaped support posts.

9. The cart according to claim 8, wherein the kickstand comprises:
a foot at a first end of the kickstand; and
a swivel joint at an intermediate portion of the kickstand adjacent to the cross post configured to enable rotational movement of the kickstand;
wherein the kickstand is configured to be retractable into and out of a hollow passage formed through the cross post.

10. The cart according to claim 9, wherein the kickstand further comprises:
a flange at a second end of the kickstand disposed within the hollow passage;
wherein the flange has a greater diameter than a lip or throat in the hollow passage formed through the cross post.

11. The cart according to claim 3, wherein each of the at least two T-shaped support posts can be rotated at least 90 degrees relative to the elongated member.

12. The cart according to claim 2, wherein the axle is received in the elongated member of the frame.

13. The cart according to claim 12, wherein the axle is secured to the frame by a spring release button clip.

14. The cart according to claim 1, wherein the wheels are attached to the axle with a quick release pin and wherein the wheels comprise a bushing configured to receive the axle.

15. The cart according to claim 1, further comprising a coupling attached to the end of the axle configured to accommodate wheels of variable sizes.

16. The cart according to claim 1, wherein the axle has an adjustable length.

17. The cart according to claim 1, wherein the at least two elongated ties are made of a flexible and moldable material.

18. The cart according to claim 17, wherein the at least two elongated ties are made of a material comprising a wire interior and an exterior comprising a gripping surface.

19. The cart according to claim 1, wherein the wheel chocks comprise a surface having a plurality of bumps, groove or projections thereon to providing a gripping surface.

20. The cart according to claim 19, wherein the wheel chocks are configured to grip a side of the aquatic vessel during transport of the aquatic vessel on the cart.
